(19) United States
(12) Patent Application Publication
(10) Pub. No.: US 2004/0068902 A1
(43) Pub. Date: Apr. 15, 2004

(54) Tag for intravenous infusion systems

(75) Inventors: Admir Hadzic, Montclair, NJ (US); Sergio Giglioli, Mirandola (IT)

Correspondence Address: FITCH EVEN TABIN AND FLANNERY, 120 SOUTH LA SALLE STREET, SUITE 1600, CHICAGO, IL, 60603-3406, US

(73) Assignee: Macosta Medical U.S.A., L.L.C.

(21) Appl. No.: 10/269,275

(22) Filed: Oct. 11, 2002

(51) Int. Cl. G09F 3/00

(52) U.S. Cl. 40/316

(57) ABSTRACT

A removable apparatus for identification of fluid-transmitting systems including a tube system, such as intravenous infusion systems, is disclosed. The apparatus may include a relatively rigid member. The apparatus includes a holder for connecting the apparatus to a portion of the tube system or fluid conduit. The holder can include a clip or clips formed by a pair of spaced arms configured for gripping on the tube secured in place thereon by frictional engagement of the clip arms on the outer surface of the tube wall. In one form, the arms extend up from a first face adjacent a lateral edge of the rigid member. The apparatus may include a portion for receiving written information, and may include a portion with pre-printed information. The information may relate to the patient, the treatment, the fluid or an additive thereto, or to the tube, tube system, or apparatus itself.

### FIELD OF THE INVENTION

The present invention relates to a label apparatus, and in particular to a tag or label apparatus for use with a tube of an intravenous infusion system or other fluid-delivery system.

### BACKGROUND OF THE INVENTION

A principal means for delivering fluid medicaments to a patient in a hospital, clinic, operation, or emergency situation is through the use of an intravenous (IV) infusion system or drip bag. These systems include a fluid-containing elevated bag with a tube connected to and in fluid communication with the bottom of the bag. The other end of the tube may be in fluid communication with a needle or insertion apparatus a portion of which is inserted intravenously in the patient, or may be in fluid communication with a pump apparatus that monitors the flow of a plurality of fluids and directs the plurality of fluids into a patient intravenously.

A variety of fluids are administered to various patients. In addition, an individual patient may receive a plurality of fluids simultaneously. Often, each fluid-containing bag is detachably connected by a clear, plastic tube to a flow-monitoring apparatus through a plurality of inlets on the apparatus. The bags containing the multiple fluids are often hung from a standard so that the fluids flow, or are assisted, by force of gravity. Typically, the bags themselves are clear with writing on them indicating their original contents. Accordingly, at quick glance the bags do not differentiate themselves.

Health care providers and technicians must be able to recognize the bags and determine their contents, whether multiple bags are connected to a patient or not. When multiple bags are connected to the flow monitor by an often lengthy tube, the health care providers must know which bag is which (and which tube is connected to which bag) in order to ensure that the each bag's flow is properly monitored. At times, a syringe may be used to inject an additive, such as a medication, to a bag or its tube, and this information should be apparent so the bag or tube that received the additive is identifiable, as is the additive itself. Furthermore, instructions and other information are often provided for the bags, such as when the bag was connected, how long it should be connected, and how much fluid should be delivered to the patient.

Typically, the bags are identified by adhering a tape or pressure sensitive adhesive label to the tube of the bag. With tape, many practical problems are introduced. Writing on adhesive tape can be problematic as the tape needs to be taken off a dispenser roll typically and then placed down on flat, stiff or hard writing surface so that medical personnel can legibly write on the non-adhesive surface of the tape. If not enough tape is removed for the label or the information as written takes up too much space on the tape surface, then when the tape is wrapped around the tube, that portion of the tape in contact with the tube may have writing thereon. This generally will make the writing very difficult to decipher as it too will wrap around the tube.

Some of the same concerns are present with pressure-sensitive labels, especially if they are not provided with a removable backing on their back adhesive surface. With both tape and labels, if they are wrapped unevenly or in a skewed manner so that the two portions extending away from the tube do not match there will be a sticky portion exposed which can attract dirt and bacteria, or can undesirably stick to another object. In practice, it is difficult to make legible notations on a soft label piece of tape once it is adhered to the tube. The labels also tend to be either paper or cloth which both suffer if a spilled or leaked fluid contacts the label. Adhesive from the label often remains on the tube after the label is removed, adhesive that attracts dirt and bacteria and requires labor to clean. Cleaning the tube with a solvent may cause degradation of the integrity of the tube or may introduce undesirable residual chemicals in a controlled environment such as an operating room.

In addition to intravenous infusion systems or drip bags, it is also desirable to be able to identify the fluids flowing through other tube systems. For instance, a person on a breathing apparatus may be connected to a tube providing oxygen, and/or a tube delivering gaseous anesthesia. In such a case, health care providers need to differentiate between the separate tubes or recognize what gas is being delivered by a tube. The tube systems for delivering fluid medicaments (including gasses) the use of which would benefit from the identification of the tubes or their fluids are not limited to the provided examples.

### SUMMARY OF THE INVENTION

In accordance with the present invention, a tag is provided for a fluid medicament delivery system that treats patients by intravenously infusing various types of fluids via flexible tubes extending from fluid sources such as flexible bags or pouches. Alternatively, the tag can also be used for non-intravenous delivery of gases to a patient. The tag provides medical personnel with a user-friendly indicia receiving member as it allows for writing to be received thereon that is more easily applied and/or read versus prior adhesive-based labels or tape. Preferably, the tag member is a shape-retentive or relatively rigid molded plastic member that provides the medical personnel or health care providers a substantially stiff or hard surface so that they can write legibly thereon. Also, the tag member is provided with a holder or holders oriented relative to the surface receiving the writing so that the surface extends in a predetermined orientation away from the tube allowing the information written on the tag to be clearly read by doctors, nurses and the like.

In a preferred form, the tag includes a rigid molded member having a clip including a pair of holding arms, and most preferably two sets of clips or holding arm pairs. The arms in a set are spaced from each other so that one of the tubes of an IV set, for instance, can be frictionally received therebetween. The friction fit with the arms is preferably such that the tag can be easily slid to various locations along the tube but when released will stay in place thereon. In this manner, several tags used for example on closely adjacent tubes delivering different medicaments can be repositioned so as to create a minimum of interference with the surrounding equipment including such things as monitors, tube stands, patient beds and their controls, as well as the other tubes and tags associated with the fluid delivery system, e.g. I.V. set.

### BRIEF DESCRIPTION OF THE DRAWINGS

FIG. 1 is a perspective view of a tag in accordance with the present invention showing a rigid member having clip holders for releasably attaching the member to a tube and an intravenous infusion bag;

FIG. 2 is a front side elevation view of the tag of FIG. 1 showing the clip holders;

FIG. 3 is a perspective view of the tag of FIG. 1 showing a flat surface for displaying information relating to the treatment provided by the fluid medicament delivered through the tube to which the tag is attached;

FIG. 4 is a perspective view of the tag of FIG. 1 showing a flat surface for receiving and displaying information relating to the treatment provided by the fluid medicament delivered through the tube to which the tag is attached; and

FIG. 5 is a perspective view of a plurality of intravenous infusion bags hanging from a standard with the bags having tubes that deliver fluid medicaments from the bags to a patient.

### DETAILED DESCRIPTION OF THE PREFERRED EMBODIMENT

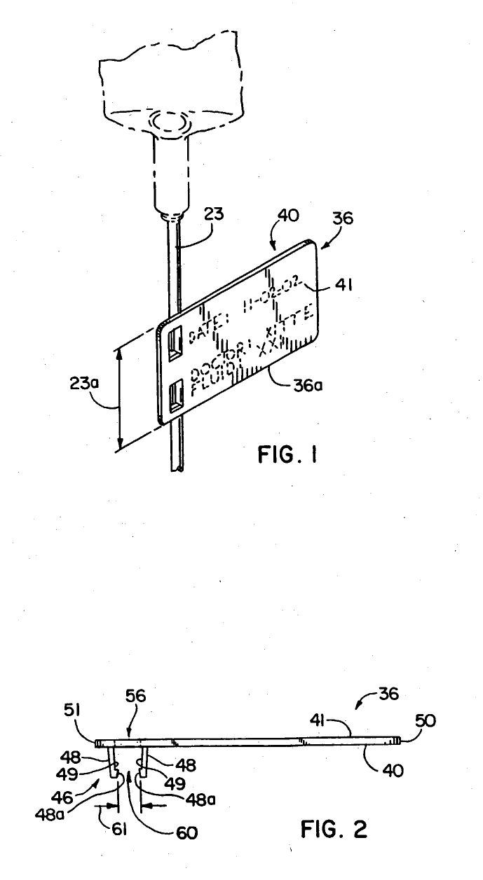

Referring initially to FIGS. 1-4, an identification apparatus or tag 36 of the present invention is depicted connected to a fluid conduit or tube 23 which is part of a tube system (see FIG. 5 and accompanying discussion). The tag or tag member 36 can be of a polymeric or plastic material such as polyethylene (injection-molded), though it may be metal or another material. The illustrated tag 36 has a rectangular configuration such as with a length of approximately 2 to 4 inches, and a width of approximately 1 to 3 inches, though different shapes therefor could be utilized, e.g. round or oval. The tag 36 can have a thickness between 1/16and ⅛ of an inch so that the tag 36 is sufficiently rigid that one may write on the tag 36 when the tag 36 is attached to the tube 23 or a tube system 22 (FIG. 5) while not using excessive material, though the tag 36 may still remain somewhat flexible.

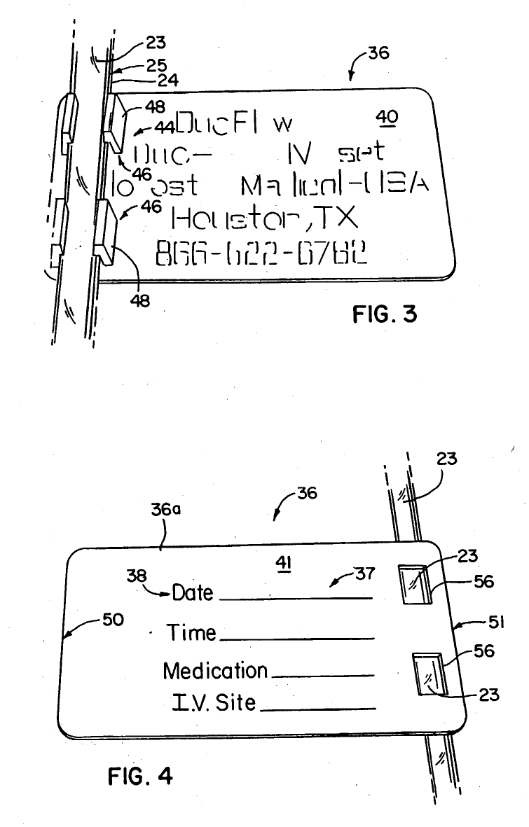

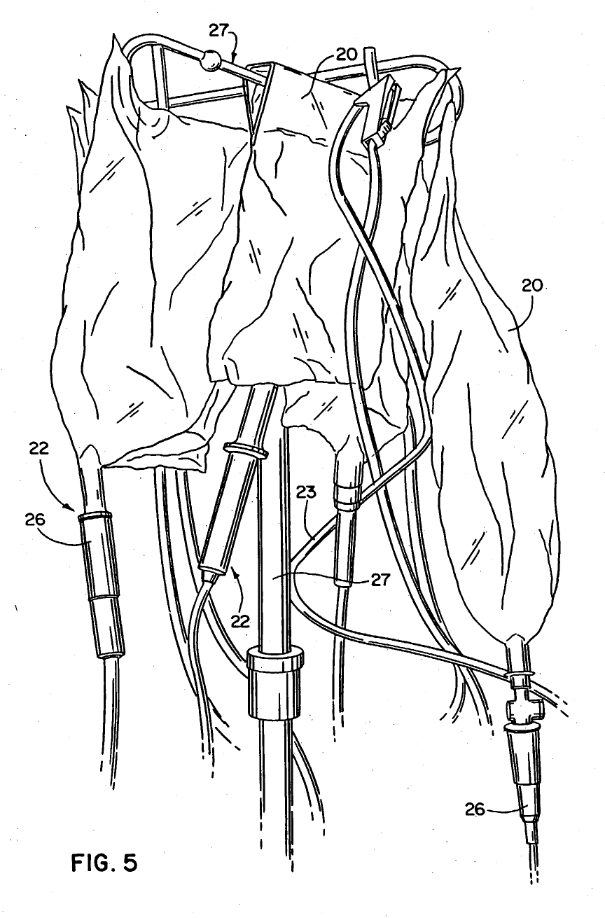

The tag 36 preferably has a flat card-like configuration and has a first face 40 (FIG. 3) and a second face 41 (FIG. 4) adapted for receiving writing thereon, each being a substantially flat surface. The first face 40 includes at least one holder 44 for attaching the tag 36 to the tube 23. As mentioned, the tag 36 is a substantially card-like and rigid member, although it could be thin and somewhat flexible yet shape-retentive so that the surface is still stiff or hard to allow the user to easily write thereon. In this regard, if the flexible card member 36 is resiliently bent by a user, for example, and then released, it will rebound back to its flat card-like configuration, unlike prior tape or pressure-sensitive labels used to identify fluid medicaments, as previously has been discussed.

In the preferred and illustrated form, there is a pair of clip holders 46. Each clip holder 46 can include tube engaging portions in the form of a pair of spaced arms 48 (or holding arms) that generally project upwardly (or downwardly as the case may be) in a direction generally orthogonal to the first face 40.

Referring to FIGS. 2 and 3, the arms 48 include inner facing surface portions 49 that are spaced by a predetermined gap distance 61 (FIG. 2) from each other so that they engage onto an outer surface 24 of tube wall 25 to hold the tag 36 in place along the length of the tube 23. As such, the spacing of surface portions 49 is coordinated with the outer diameter of the wall 25 such that the arms 48 frictionally engage onto the wall surface 24, such at diametrically opposite portions thereof.

Preferably, the friction fit of the arms 48 onto the tube wall 25 does not materially affect fluid flow through the tube 23. In this regard, the tag member 36 is preferably relatively light in weight so that only a light friction fit is needed to hold it in place on the tube 23. In this manner, the arms 48 friction fit onto the tube outer surface 24 do not need to create an undue reduction in the internal diameter of the tube wall 25 through which the fluid medicaments are flowing. Also, this light friction fit allows the tag 36 to be easily slid to different positions along the length of the tube 23. In this way, the position of the tag 36 readily can be adjusted and optimized both from a viewing standpoint, e.g. higher up toward the bag, and to avoid interfering with surrounding equipment such as other tubes and their associated tags.

The facing arm surfaces 49 can have a flat configuration that taper toward each other as they extend from the back card surface 40 to their enlarged free, distal ends 48a. Alternatively, these surfaces 49 can have an arcuate configuration to, for example, substantially conform to the tube outer surface 24. The spacing between the distal ends 48a is less than the outer diameter of the tube wall. The tag 36 is mounted to the tube 23 by fitting the tube 23 through a small opening 60 formed between the arm ends 48a. If the arms 48 are rigid, the tube wall 25 is compressed as it is inserted into the space between the arms 48, and then resiliently expands back toward its undeformed configuration when frictionally captured between the arms 48. Alternatively, the arms 48 can be flexible so that both the flexible tube 23 and particularly tubular wall 25 thereof and arms 48 resiliently deflect to allow the tube 23 to fit through the opening 60 which increases in size to allow passage of the tube 23 therethrough during the tag attachment process. To detach the tag 36 from the tube 23, substantially the reverse operation is undertaken for pulling the tag 36 off the tube 23 with the tag 36 fitting through the arm opening 60 provided between the distal arm ends 48a. The length of the arms 48 is such that the spacing of the enlarged ends 48a thereof is preferably approximately the same or slightly less than the tube outer diameter. Accordingly, when the tube 23 is fully received between the arms 48 such as with the tube engaged against the card surface 40, the arm ends 48a will be in frictional contact with the tube outer surface 24 tending to push the tube toward the tag surface 40 to keep it securely held therebetween.

The arms 48 can extend up from the tag surface 40 adjacent to one end edge 51 of the tag member 36 so that the vast majority of the tag surfaces 40, 41 project away from the tube 23 along one side thereof. In the illustrated form employing two clip holders 46, they are aligned along the edge 51 so that when releasably connected onto the tube wall 25, the tube 23 runs generally parallel to the edge 51 with the long length of the tag member 36 extending laterally out therefrom generally perpendicular to the axis of the tube portion 23a captured by and extending between the clip holders 46 (FIG. 1).

A through opening 56 can be provided in the body 36a of the tag 36, with the arms 48 extending up along either side of the opening 56 (FIGS. 2 and 4). Thus, during the tag attachment process, the tube 23 can be pushed between the arms 48 as previously described with a portion of the tube 23 extending into the opening 56 to ensure that the tube 23 is fully inserted and captured between the arms 48. This opening 56 also provides the tube 23 space into which it can project when frictionally captured between the arms 48. In this way, even if the arms 48 deform the tube wall 25, the opening 56 can take up some or all of this tube deflection so that the internal tube diameter is substantially maintained constant to avoid constricting flow of fluid medicaments therethrough.

Manifestly, various types and numbers of holders 44 could be used for attaching the tag 36 to the tube system 22. For instance, different numbers and orientation of clip holders 46 could be employed. The holder 44 may consist of a single clip holder 46 including a pair of arms 48 as described. Optionally, the at least one clip holder 46 can extend laterally out from either one of the lateral end edges 50 or 51. Other forms of holders 44 include a circular channel opening of a diameter approximately the same or slightly larger than the tube wall 25 and through which the tube 23 is inserted such that the tag 36 may not be accidentally removed from the tube 23 absent disconnecting the tube at either end thereof to slide the tag 36 off therefrom. In another form, the tag 36 may include a holder 44 substantially similar to the clip arms 48 as described above, and may further include a cover which is removably secured to an end of the arms 48 such that the tag 36 resists accidental removal. In another embodiment, the tag 36 may be attached to one of the apparatuses discussed above for monitoring the flow or delivering an additive. The tag 36 may also be formed integral with the tube system 22. The tag 36 may also be glued or otherwise adhered to the tube system 22.

Referring now to FIG. 4, the second face 41 of the tag 36 is depicted, the tag 36 connected to a tube 23 which is visible through openings 56 where the arms 48 are attached to first face 40 (FIGS. 2 and 3). The second face 41 provides a relatively large space for handwriting for patient or treatment-specific information. The space may be accompanied with integrally formed pre-printed or molded indicia where the indicia is raised or recessed. The indicia may include specific fields of information. The fields may have predetermined locations such as the word “MEDICATION” followed by a blank space in which a health care provider may hand-write a medication name and/or dosage. In addition, the indicia may include the words “DATE,” “TIME,” and “IV SITE” with an accompanying blank space for a health care provider's handwriting. To this end, in addition to providing a large space, the surface 41 of the plastic tag member can be further adapted for receiving writing thereon, such as by use of a coating of material on the surface 41 that allows writing from a typical writing implement, e.g., a pen or pencil, to be received and clearly read thereon. Alternatively, a pre-printed label can be adhesively attached onto the surface 41 so that there is a paper surface or the like on the tag member that can receive handwriting from medical personnel thereon.

In the present embodiment, either the first face 40 (FIG. 3) or the second face 41 (FIG. 4) of the tag 36 may be used for identification purposes, or both. The tag 36 may include information 38 and fields 37 (which may receive and display information 38) specific to the fluid or treatment being delivered through the tube 23 such as the date and time that administration of the fluid began, the medication, the responsible medical personnel (such as doctor, nurse, paramedic, or other health care provider), the site of the intravenous entry, etc. The tag 36 may further include additional information specific to the tag 36, bag 20, or the tube system 22 such as the manufacturer or source of the tag 36 including re-ordering information, product information or warnings regarding use of the bag 20, tag 36, or tube system 22, or other information. It is preferred that the tag 36 is disposable or reusable, and the information 38 and fields 37 provided thereon may be altered or the information 38 is standard such that it could be used with multiple bags 20 over a service lifetime. In addition, the tag 36 may incorporate a printed label having a backing of pressure sensitive adhesive (not shown) which may be placed on one of the faces 40, 41 of the tag 36 to provide the fields 37 in a pre-printed form on the tag 36.

The tag 36 may be coded to indicate the type of medicament to be delivered through the tube 23 to which the tag 36 is to be attached. For example, the tags 36 can be color coded with each color representing a different fluid medicament. The color may be fluorescent to enhance or facilitate visibility of information or fields on or designated by the tag in low-light situations such as patient transfer, a military field hospital, ambulances, patient wards at night, or operating rooms.

Referring now to FIG. 5, a plurality of fluid-containing bags 20 for intravenously delivering fluid based medicaments or substances or medicaments for which a fluid provides a transport to a patient are depicted. As used herein, a medicament is any substance provided to a patient in the course of a treatment regime regardless of intrinsic medicinal properties such that the term medicament is meant to include, for example, saline and de-ionized or purified water. In addition, medicaments can include oxygen or other gases delivered to a patient. The bags 20 at least in part rely on gravity to assist with fluid delivery to a tube system 22, and accordingly hang from a standard 27. The tube system 22 is a fluid conduit and may include a flexible tube 23, and an apparatus for manual control or adjustment of characteristics of fluid flow, such as the flow rate or contents of the fluid. For instance, the tube system 22 may include an apparatus 26 for monitoring flow between the tube 22 and the bag 20, or an apparatus (not shown) for injection of an additive, such as a medication or drug, to the fluid, or other apparatuses. The tube system 22 may extend between the bag 20 and a patient, or between the bag 20 and a device for delivering the fluid to a patient. Typically, the bags 20 are received by a health care facility pre-filled. That is, the fluids are delivered pre-packaged within the bag 20 for sterility and safety purposes. The bags 20 are clear so that a health care provider may easily identify the quantity of fluid remaining in the bag 20. Accordingly, the fluid within the bag 20 is typically identified with simple writing on the exterior of the bag 20.

Often times, such as during a surgical operation, a plurality of fluid-containing bags 20 are utilized for a single patient. As the bags 20 tend to look similar, and as the bags are connected to tubes 23 that tend to look similar, health care providers must take care in identifying the fluid bags 20. Often a plurality of tube systems 22 is connected to a plurality of inputs (not shown) of an intravenous infusion flow monitor (not shown). Each input is attributable to a different fluid, and, hence, bag 20. The flow monitor is often located at a distance from the bags 20. Therefore, when connecting the tube systems 22 of the bags 20 to the monitor, care must be taken to correctly connect a particular tube system 22 and its accompanying bag 20 to the proper flow monitor input.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

1. A tag for fluid medicament delivery systems to provide information regarding a particular treatment to medical personnel, the tag comprising:
a relatively rigid member having a predetermined configuration;
a substantially flat surface on the rigid member for receiving written or printed information thereon regarding the treatment being provided; and
at least one holder connected to the rigid member configured for attaching the rigid member at a predetermined position along a fluid conduit of the medicament delivery system.

2. The tag of claim 1 wherein the rigid member has a flat card configuration including opposite flat surfaces, and the holder includes a pair of spaced holding arms projecting up from one of the surfaces of the rigid card member.

3. The tag of claim 1 wherein the rigid member has a generally rectangular configuration including opposite edges and the at least one holder includes a pair of holders aligned adjacent to and along one of the rigid member edges.

4. The tag of claim 1 wherein the flat surface includes a plurality of fields at predetermined locations on the surface at which appropriate information is to be included on the surface.

5. The tag of claim 4 wherein the fields include indicia integrally formed with the rigid member.

6. The tag of claim 4 wherein the fields are on printed labels for being attached onto the flat surface of the rigid member.

7. The tag of claim 1 wherein the holder includes engaging portions for frictionally contacting the conduit at diametrically opposite locations thereon.

8. The tag of claim 1 wherein the holder has engaging surface portions configured to releasably attach the rigid member to the fluid conduit to allow the member to be reusable for providing information relating to treatments for different patients.

9. The tag of claim 1 wherein the rigid member has a substantially flat surface opposite the surface for receiving the written or printed information, and indicia formed integrally with the rigid member for providing source and product information relating to the tag.

10. The tag of claim 1 wherein at least a portion of the tag is color coded to provide information to medical personnel.

11. The tag of claim 1 wherein at least a portion of the tag has a fluorescent color to enhance the ability of medical personnel to identify the information provided in low light environments.

12. A medicament delivery assembly comprising:
a source of fluid medicaments;
a flexible tube extending between the fluid source and a patient for receiving the fluids intravenously;
an indicia receiving member on which information regarding treatment conditions relating to the intravenous fluid medicament delivery is to be received; and
a pair of holding arms of the member that are spaced by a predetermined distance to allow the arms to frictionally engage on the flexible tube and keep the member substantially stationary thereon.

13. The medicament delivery assembly of claim 12 wherein the indicia receiving member comprises a card member having a flat surface on which written or printed information is to be received.

14. The medicament delivery assembly of claim 12 wherein the indicia receiving member is a rigid molded plastic member that provides a stiff writing surface to allow the information to be legibly written on the member while attached to the tube.

15. The medicament delivery assembly of claim 12 wherein the member has predetermined fields for the information including date, time, medication, and intravenous site.

16. The medicament delivery assembly of claim 12 wherein the member includes a flat surface portion for receiving the treatment condition information written or printed thereon, the pair of holding arms includes two sets of holding arms with each set having a gap spacing therebetween, and the gap spacings are aligned with each other along one side of the member so that with the member attached to the tube, the flat surface portion of the member with all the treatment condition information thereon projects away from the tube.

17. The medicament delivery assembly of claim 16 wherein the tube has a predetermined outer diameter, and the gaps between the sets of arm pairs are spaced by a distance less than the tube diameter so that the tube diameter is reduced at the portions of the tube received between the arm pairs.

18. The medicament delivery assembly of claim 12 wherein the indicia receiving member is a rigid card member of molded plastic material, the card member has a through opening and the arms project from the card member or either side of the opening to allow the tube to be pushed between the arms and into the opening therebetween during attachment of the card member to the tube.

19. The medicament delivery assembly of claim 12 wherein the arms each include an enlarged distal end with the arms being sized such that the enlarged arm ends grip around the tube for securely capturing the tube between the arms.

20. The medicament delivery assembly of claim 12 wherein the tube comprises a plurality of tubes for delivering different fluid medicaments to the patient, and the holding arms are configured to allow each indicia receiving member to be slidingly received on a tube so that adjacent tubes delivering different fluid medicaments can each have an indicia receiving member.
